(19) United States
(12) Patent Application Publication
(10) Pub. No.: US 2026/0277508 A1
(43) Pub. Date: Sep. 17, 2026

(54) IMAGE FORMING SYSTEM

(71) Applicant: RISO KAGAKU CORPORATION, Tokyo (JP)

(72) Inventor: Yukimori MATSUMINE, Tokyo (JP)

(73) Assignee: RISO KAGAKU CORPORATION, Tokyo (JP)

(21) Appl. No.: 19/557,709

(22) Filed: Mar. 5, 2026

(30) Foreign Application Priority Data
Mar. 12, 2025 (JP) 2025-038850
Feb. 5, 2026 (JP) 2026-017485

(51) Int. Cl. G06F 3/12; G01S 11/02; H04N 1/00

(52) U.S. Cl. CPC G06F 3/121; G01S 11/02; G06F 3/1234; H04N 1/00037; H04N 1/00082

(57) ABSTRACT

There is provided an image forming system including: an image forming unit that forms an image on a medium; at least one feeding unit that feeds the medium to the image forming unit; at least one discharge unit that discharges the medium on which an image is formed by the image forming unit; and a control unit that controls an operation of each of a plurality of control target parts including the image forming unit, the feeding unit, and the discharge unit, in which a wireless transmitter and a wireless receiver are provided, and the control unit detects a human body and a posture from a reception signal obtained by receiving a radio wave transmitted from the wireless transmitter by the wireless receiver, and determines the control target part near the human body.

### CROSS-REFERENCE TO RELATED APPLICATION

This application is based upon and claims the benefit of priority of the prior Japanese Patent Applications No. 2025-038850 filed on Mar. 12, 2025 and No. 2026-017485 filed on Feb. 5, 2026, the entire contents of which are incorporated herein by reference.

### FIELD

Embodiments discussed herein are related to an image forming system.

### BACKGROUND

In an image forming apparatus that forms an image on a medium such as paper, there is known an image forming apparatus that detects an operator approaching the image forming apparatus by using a human sensing sensor such as an ultrasonic sensor and returns from a power saving state to a normal state. In such management of the power control of the image forming apparatus, in order to improve accuracy of the return determination from the power saving state, a technique of performing machine learning by using a sense value of the human sensing sensor and operation information of an operation unit of the apparatus, and performing return determination from the power saving state by estimating that an operator intends to operate the apparatus from the sense value and the operation information has been proposed (for example, Japanese Patent Laid-Open Publication No. 2020-038538).

In addition, a human body movement trajectory detection apparatus that calculates a standing position and a movement trajectory of a passing human body by using a plurality of human sensing sensors is known (for example, Japanese Patent Laid-Open Publication No. 2010-071688).

The operation to be performed on the image forming apparatus by a user is not limited to the operation on the operation unit, and includes various operations such as replenishment of paper (sheet) that is a medium on which an image is to be formed, transfer of paper discharged after image formation, resolution of an error in a case where a transport failure of paper occurs, and replenishment or replacement of ink or toner. Therefore, in the image forming apparatus, there is a demand for improving usability of the image forming apparatus by performing operation management corresponding not only to returning from the power saving state but also to various operations that the user intends to perform.

For example, in a case where a user replenishes paper in a paper feeding unit of the image forming apparatus, there is a request for suspending an operation of the paper feeding unit. In addition, in a case where a user is carrying out paper discharged to a paper discharge unit of the image forming apparatus, there is a request for suspending an operation of the paper discharge unit. In such a case, in the determination based on the sense value of the human sensing sensor and the operation content of the operation unit as in Japanese Patent Laid-Open Publication No. 2020-038538, there is a problem that it is difficult to detect an access of a user to a specific part (the paper feeding unit or the paper discharge unit) of the image forming apparatus and to accurately control an operation of the image forming apparatus corresponding to the access. That is, in the detection using the existing human sensing sensor, it is difficult to estimate a position of a user and content of work performed by the user and to perform optimum operation control.

In addition, the configuration in which a plurality of human sensing sensors are provided as in Japanese Patent Laid-Open Publication No. 2010-071688 has a problem that an installation area and a mounting position of the sensors in the image forming apparatus are likely to be restricted. In particular, as a size of the image forming apparatus is increased, it is necessary to widen a detection range of the human sensing sensor, and it is difficult to realize arrangement of the human sensing sensors to cover a wide detection range.

As a different method of human body detection in the image forming apparatus, a method of providing an image capturing unit, analyzing an image captured by the image capturing unit, and determining a position of a user, content of work, and the like is considered. However, in this method, there is a concern that personal information such as a user's face or a document that is not a subject for which information disclosure is allowed may be reflected in the captured image. For this reason, there is a problem that it is not appropriate to perform image capturing by the image capturing unit from the viewpoint of privacy and security as a method for acquiring information related to a use status of the image forming apparatus in a company or a public institution.

### SUMMARY

According to an aspect, there is provided an image forming system including: an image forming unit that forms an image on a medium; at least one feeding unit that feeds the medium to the image forming unit; at least one discharge unit that discharges the medium on which an image is formed by the image forming unit; and a control unit that controls an operation of each of a plurality of control target parts including at least the image forming unit, the feeding unit, and the discharge unit, in which a wireless transmitter and a wireless receiver are provided, and the control unit detects a human body and a posture from a reception signal obtained by receiving a radio wave transmitted from the wireless transmitter by the wireless receiver, and determines the control target part near the human body.

An object and advantages of the invention will be realized and attained by means of the elements and combinations particularly pointed out in the claims.

### BRIEF DESCRIPTION OF THE DRAWINGS

FIG. 1 is a front view illustrating a schematic configuration of an image forming system;

FIG. 2 is a plan view of the image forming system;

FIG. 3 is a block diagram illustrating a control system of the image forming system;

FIG. 4 is a diagram illustrating a display example of a use prevention notification and a use prevention selection menu on an operation unit of the image forming system;

FIG. 5 is a flowchart illustrating a flow of processing in the image forming system; and

FIGS. 6A and 6B are diagrams illustrating a display example of an operation mode setting menu on the operation unit of the image forming system.

### DETAILED DESCRIPTION

Hereinafter, an image forming system according to the present disclosure will be described with reference to the illustrated embodiment. The illustrated embodiment is applied to an image forming system 10 that forms an image on paper (not illustrated) that is a medium for image formation. Note that the medium on which an image is to be formed in the image forming system 10 is not limited to paper, and may be a sheet-shaped material other than paper. Therefore, paper feeding (supply of paper) and paper discharge (discharge of paper) in the image forming system 10 are respectively examples of feeding and discharge of a medium.

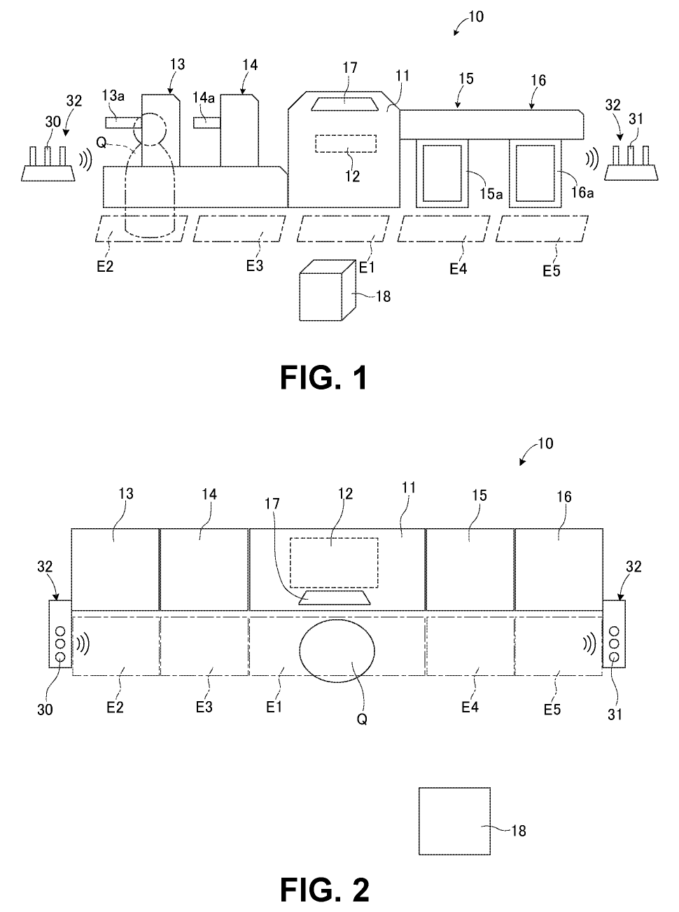

As illustrated in FIGS. 1 and 2, the image forming system 10 includes an image forming unit 11 including an image forming module 12 therein, a first paper feeding unit 13 and a second paper feeding unit 14 that are paper feeding units for feeding paper to the image forming unit 11, and a first paper discharge unit 15 and a second paper discharge unit 16 that are paper discharge units for discharging paper from the image forming unit 11. The image forming system 10 in the present specification means an image forming apparatus in a broad sense including not only the image forming unit 11 that is an image forming apparatus in a narrow sense but also related devices such as paper feeding units (the first paper feeding unit 13 and the second paper feeding unit 14) and paper discharge units (the first paper discharge unit 15 and the second paper discharge unit 16).

An operation unit 17 included in the image forming system 10 is an input part for allowing an operator Q to perform an operation related to the image forming system 10, and is also a notification unit (display unit) for notifying the operator Q of information related to the image forming system 10. The operation performed by the operator Q via the operation unit 17 includes various content, and includes, for example, setting of various parameters, an operation execution instruction and an operation stop instruction, selection of content of the operation, and the like. In the configuration example illustrated in FIG. 1, the operation unit 17 is disposed on an outer surface of an upper portion of the image forming unit 11. Note that the operation unit 17 may be disposed at a location different from the image forming unit 11.

The operation unit 17 is, for example, a touch-panel-type input device that receives information which is input when the operator Q touches a screen, and can switch display of the screen according to the content to be input. Note that the operation unit 17 is not limited to a touch-panel-type input device, and various input devices such as a keyboard, a switch, and a push button may be applied.

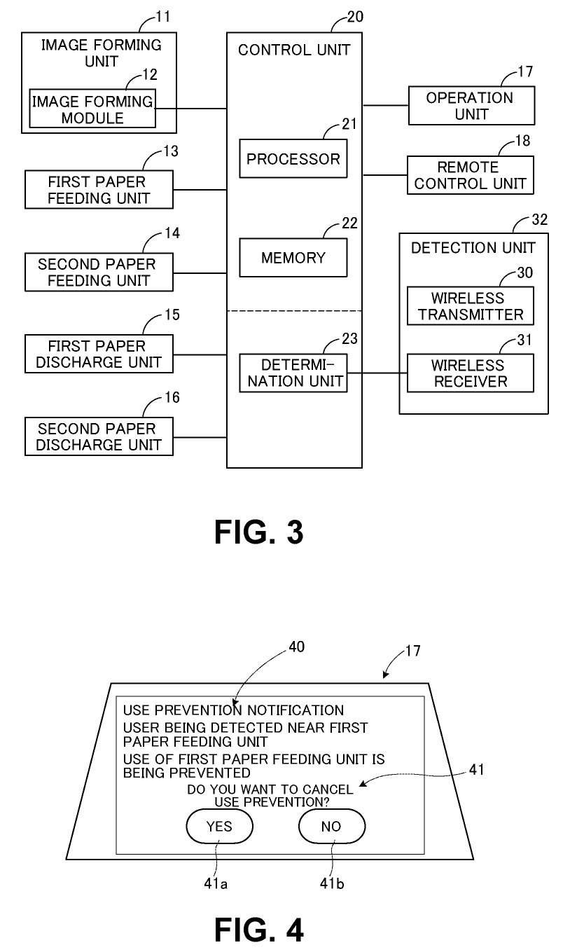

A remote control unit 18 is located away from the image forming unit 11, the paper feeding units 13 and 14, and the paper discharge units 15 and 16, and is communicably connected to a control unit 20 (FIG. 3) to be described later via wired or wireless communication means. The remote control unit 18 is, for example, a personal computer, a portable terminal such as a smartphone or a tablet computer, or the like.

As illustrated in FIG. 3, the image forming system 10 includes a control unit 20 that controls each part. The control unit 20 is disposed, for example, in a housing of the image forming unit 11. The control unit 20 includes, as a hardware configuration, a processor 21 such as a central processing unit (CPU) and a memory 22 that is a storage unit. The memory 22 includes a read only memory (ROM) in which a program for controlling the image forming system 10 is stored, and a random access memory (RAM) used as a temporary data storage area. By reading a program stored in the ROM of the memory 22 and performing arithmetic processing by the processor 21, various determinations, decisions, and the like are performed, and each part of the image forming system 10 is controlled. A series of operations and processes of the image forming system 10 that are to be described later are executed according to the program stored in the memory 22.

As illustrated in FIGS. 1 and 2, the image forming module 12 is provided in the image forming unit 11. The image forming module 12 is a part for forming an image on paper. A method by which the image forming module 12 forms an image on a medium is not limited, and for example, an inkjet method of ejecting an ink from an inkjet head toward a medium, a stencil printing method of extruding an ink from a hole formed on a plate toward a medium, a letterpress printing method or an intaglio printing method of transferring an ink attached to a plate having irregularities to a medium, an electrophotographic image forming method using an electrophotographic process, and the like can be applied.

The image forming system 10 includes a first paper feeding unit 13 and a second paper feeding unit 14 as paper feeding units for feeding paper to the image forming unit 11, the paper being a medium for forming an image. The first paper feeding unit 13 includes a paper feeding tray 13a, the second paper feeding unit 14 includes a paper feeding tray 14a, and sheets of paper on which an image is not formed are loaded on each of the paper feeding trays 13a and 14a. The sheets of paper loaded on each of the paper feeding trays 13a and 14a are transported one by one to the image forming unit 11 by a medium transport mechanism (not illustrated). A paper feeding operation can be individually performed from the first paper feeding unit 13 and the second paper feeding unit 14, and a state in which paper is fed from the first paper feeding unit 13 to the image forming unit 11 and a state in which paper is fed from the second paper feeding unit 14 to the image forming unit 11 can be selected under the control of the control unit 20.

The image forming system 10 includes a first paper discharge unit 15 and a second paper discharge unit 16 as paper discharge units for discharging paper on which an image is formed by the image forming unit 11. The first paper discharge unit 15 includes a paper discharge tray 15a, and the second paper discharge unit 16 includes a paper discharge tray 16a. The paper on which an image is formed using the image forming module 12 is discharged from the image forming unit 11 by a medium transport mechanism (not illustrated), and is loaded on each of the discharge trays 15a and 16a. A paper discharge operation can be individually performed by the first paper discharge unit 15 and the second paper discharge unit 16, and a state of discharging the paper from the image forming unit 11 to the first paper discharge unit 15 and a state of discharging the paper from the image forming unit 11 to the second paper discharge unit 16 can be selected under the control of the control unit 20.

A signal indicating the operation content which is input to the operation unit 17 or the remote control unit 18 is transmitted to the control unit 20. The control unit 20 controls an operation of each unit of the image forming system 10 according to the signal which is input from the operation unit 17 or the remote control unit 18. For example, the operator Q operates the remote control unit 18 such that image formation job data including information, such as image data to be formed on paper, a type of paper on which an image is to be formed, the number of sheets of paper, and the like, is transmitted from the remote control unit 18 to the control unit 20. In accordance with the received image formation job data, the control unit 20 performs an operation of feeding paper from the first paper feeding unit 13 or the second paper feeding unit 14 to the image forming unit 11, an operation of causing the image forming module 12 in the image forming unit 11 to form an image on the paper, and an operation of discharging the paper on which an image is formed from the image forming unit 11 to the first paper discharge unit 15 or the second paper discharge unit 16. That is, each of the image forming unit 11, the first paper feeding unit 13, the second paper feeding unit 14, the first paper discharge unit 15, and the second paper discharge unit 16 is a part to be controlled by the control unit 20 in the image forming processing performed by the image forming system 10.

An execution of the image formation job in the image forming system 10 may be set to be started by a remote operation from the remote control unit 18, or may be set to be started at a stage where the operator Q instructs an execution of the job via the operation unit 17 instead of being started immediately at a stage where the image formation job is input to the control unit 20. In addition, in the image formation, paper transport condition setting, such as which of the first paper feeding unit 13 and the second paper feeding unit 14 is applied as a paper feeding source and which of the first paper discharge unit 15 and the second paper discharge unit 16 is applied as a paper discharge destination, may be included in the image formation job data transmitted from the remote control unit 18 to the control unit 20, or may be set such that the operator Q operates the operation unit 17 to select a paper transport condition separately from the image formation job data.

The image forming system 10 may include a connection unit to which an external storage medium can be connected, image data stored in the external storage medium may be fetched from the connection unit into the memory 22 of the control unit 20, and an image formation job may be executed by an operation of the operation unit 17 by the operator Q. In this case, image formation can be performed without a remote operation by the remote control unit 18.

In a case where an operation is not performed for a predetermined time or longer (an operation based on the user’s operation is not performed) in a state where the main power of the image forming system 10 is turned on, the control unit 20 performs power saving control of reducing operation levels of a plurality of control target parts to reduce power consumption. In a case where the control unit 20 determines that the operator Q is about to operate the image forming system 10, such as a case where the operator Q approaches the image forming system 10, the control unit 20 performs control to return from the power saving state.

The image forming system 10 according to the present embodiment acquires operator information including a human body of the operator Q and a posture of the operator Q positioned near the image forming system 10, and not only returns from the power saving state, but also controls a plurality of control target parts including the paper feeding units (the first paper feeding unit 13 and the second paper feeding unit 14) and the paper discharge units (the first paper discharge unit 15 and the second paper discharge unit 16). Thus, an operation of the entire system is optimized, and details thereof will be described below.

As illustrated in FIGS. 1 to 3, the image forming system 10 includes a detection unit 32 including a wireless transmitter 30 and a wireless receiver 31. The wireless transmitter 30 and the wireless receiver 31 are devices that transmit and receive radio waves in accordance with IEEE 802.11bf, which is a standard for sensing using a wireless local area network (wireless LAN) (hereinafter, referred to as wireless LAN sensing) and is being developed by the Institute of Electrical and Electronics Engineers (IEEE).

The wireless LAN sensing performed using the detection unit 32 is a technique for identifying a detection target using a radio wave propagation state between the wireless transmitter 30 and the wireless receiver 31, and identifies a position and a shape of the detection target based on a change in the radio wave propagation state when a radio wave is applied to the detection target. For example, a radio wave propagation state when a radio wave is applied to an object is trained in advance, and a type, a position, a shape, and the like of a detection target are estimated by comparing a radio wave propagation state obtained by applying a radio wave to an actual detection target with the trained radio wave propagation state. In addition, a position change (movement) of the detection target is identified from variation information of the radio wave propagation obtained by applying a radio wave to the detection target that is moved.

An object detected by the detection unit 32 using the wireless transmitter 30 and the wireless receiver 31 is a human body (operator Q) positioned near the image forming system 10. Therefore, the wireless transmitter 30 and the wireless receiver 31 are installed at height positions suitable for detecting the operator Q. For example, the wireless transmitter 30 and the wireless receiver 31 are installed at a height position within a range of the assumed height of the operator Q.

As illustrated in FIG. 3, the control unit 20 includes a determination unit 23 that is a functional block implemented by the processor 21, the memory 22, and other hardware configurations. Based on information of the radio wave transmitted from the wireless transmitter 30 and information of the radio wave received by the wireless receiver 31, the determination unit 23 determines the presence or absence of a human body (operator Q) in the vicinity of the image forming system 10, a posture (a position of each part of the human body) when the human body is in the vicinity of the image forming system 10, a moving direction of the human body, and the like.

In the wireless LAN sensing in which the human body is detected by the detection unit 32, not only the approach of the human body to the image forming system 10 but also the posture of the operator Q in the vicinity of the image forming system 10 can be detected with high accuracy. Therefore, as compared with a case of using the same number of human sensing sensors as the wireless transmitter 30 and the wireless receiver 31, the amount of human body information that can be acquired is increased, and thus, it is possible to cause the control unit 20 to perform advanced determination and control based on the detected human body information.

For example, in a case where the wireless LAN sensing using the human body detection by the detection unit 32 is performed, the control unit 20 can be caused to perform not only detection of the approach of the operator Q to the image forming system 10, release from the power saving state, and returning to the normal power supply state, but also control for improving the efficiency of the work, including determination of the standing position and the posture of the operator Q and causing the determination unit 23 of the control unit 20 to estimate the work content that the operator Q intends to perform. Details of the control specifically performed by the control unit 20 based on the human body information of the operator Q will be described later.

When the human body information of the operator Q is acquired, since the detection unit 32 uses the standardized wireless LAN sensing technique, it is possible to reduce an introduction cost of the wireless transmitter 30 and the wireless receiver 31. In addition, as compared with a case where a large number of human sensing sensors are installed to obtain detailed human body information, since the detection unit 32 can be configured by including at least one wireless transmitter 30 and at least one wireless receiver 31, installation can be performed with a small installation area, and the device configuration can be simplified.

In addition, unlike the method of obtaining the human body information of the operator Q from the image obtained by capturing the periphery of the image forming system 10, in the wireless LAN sensing performed by the detection unit 32, it is possible to acquire information at a level at which personal information such as a face of the operator Q, an image to be formed on paper, and the like are not specified. Therefore, there is an advantage that problems of privacy and security are avoided and introduction is easy.

In recent years, near field communication (NFC) has been widely used as an individual identification technique by communication in various electronic devices. As an advantage compared with the near field communication, in the wireless LAN sensing performed by the detection unit 32, both the wireless transmitter 30 and the wireless receiver 31 are included on the image forming system 10 side, and the detection target (the operator Q in the case of the image forming system 10) does not need to include an electronic tag for identification. Thereby, the human body itself is the detection target, and thus, excellent convenience can be obtained. Further, in the near field communication, it is difficult to determine a detailed position, a posture, and the like of a human body that is a detection target. On the other hand, as described above, in the wireless LAN sensing, the posture of the human body, the position of each part of the human body, and the like can also be determined with high accuracy.

As illustrated in FIGS. 1 and 2, in a case where the operator Q approaches the image forming system 10 to perform work, the operator Q stays at one of a first operation position E1 in front of the image forming unit 11, a second operation position E2 in front of the first paper feeding unit 13, a third operation position E3 in front of the second paper feeding unit 14, a fourth operation position E4 in front of the first paper discharge unit 15, and a fifth operation position E5 in front of the second paper discharge unit 16. That is, each of the operation positions E1 to E5 is a virtual region where the operator Q is assumed to stay when performing work on a corresponding control target part. Thereby, the regions where the positions are to be distinguished and detected by the detection unit 32 are the operation positions E1 to E5 divided for each of the control target parts.

The image forming system 10 according to the present embodiment has a configuration in which the first paper feeding unit 13 and the second paper feeding unit 14 and the first paper discharge unit 15 and the second paper discharge unit 16 are arranged in series on both sides with the image forming unit 11 interposed therebetween. The second operation position E2, the third operation position E3, the first operation position E1, the fourth operation position E4, and the fifth operation position E5 are arranged in this order in series from the left side to the right side in FIGS. 1 and 2.

In the case of a system (bistatic sensing) in which the wireless transmitter and the wireless receiver are configured by individual devices to perform wireless LAN sensing, as illustrated in FIG. 2, it is preferable to arrange the wireless transmitter 30 and the wireless receiver 31 to be separated in a direction in which the plurality of operation positions E1 to E5 are arranged so as to have a positional relationship of sandwiching the operator Q (human body) staying at any one of the operation positions E1 to E5. Thereby, when the operator Q performs work on the image forming system 10 at any one of the operation positions E1 to E5, the operator Q is positioned on a linear radio wave path connecting the wireless transmitter 30 and the wireless receiver 31, and thus, the position, the posture, and the like of the operator Q can be easily detected with high accuracy. In addition, excellent detection accuracy can be obtained with a low-output radio wave.

A change in the radio wave propagation state that is detected by the wireless LAN sensing includes not only a state in which the radio wave transmitted from the wireless transmitter is blocked by the detection target and does not reach the wireless receiver, but also a state in which the radio wave transmitted from the wireless transmitter goes around the detection target and reaches the wireless receiver, and a state in which the radio wave transmitted from the wireless transmitter is reflected by the detection target and is received by the wireless receiver. Therefore, the technique according to the present disclosure can be applied to a device layout other than the device layout as illustrated in FIG. 2 in which the operation positions E1 to E5 are arranged in series between the wireless transmitter 30 and the wireless receiver 31.

For example, the present disclosure can also be applied to an image forming system having a configuration in which an image forming unit, a paper feeding unit, and a paper discharge unit are arranged in a U-shape in plan view. In this case, by the wireless LAN sensing, a direction of the human body, positions of the hands and the feet of the human body, a relationship of a relative distance between each part of the image forming system and the human body, and the like are detected, and it is possible to determine the control target part (the image forming unit, the paper feeding unit, the paper discharge unit) that the operator faces when intending to perform work.

Further, in the image forming system according to the present disclosure, unlike the illustrated embodiment in which one wireless transmitter 30 and one wireless receiver 31 are installed, wireless LAN sensing may be performed by applying sensing of a system in which the wireless transmitter and the wireless receiver are the same device (monostatic sensing) or sensing of a system including one wireless transmitter and a plurality of wireless receivers (multi-static sensing).

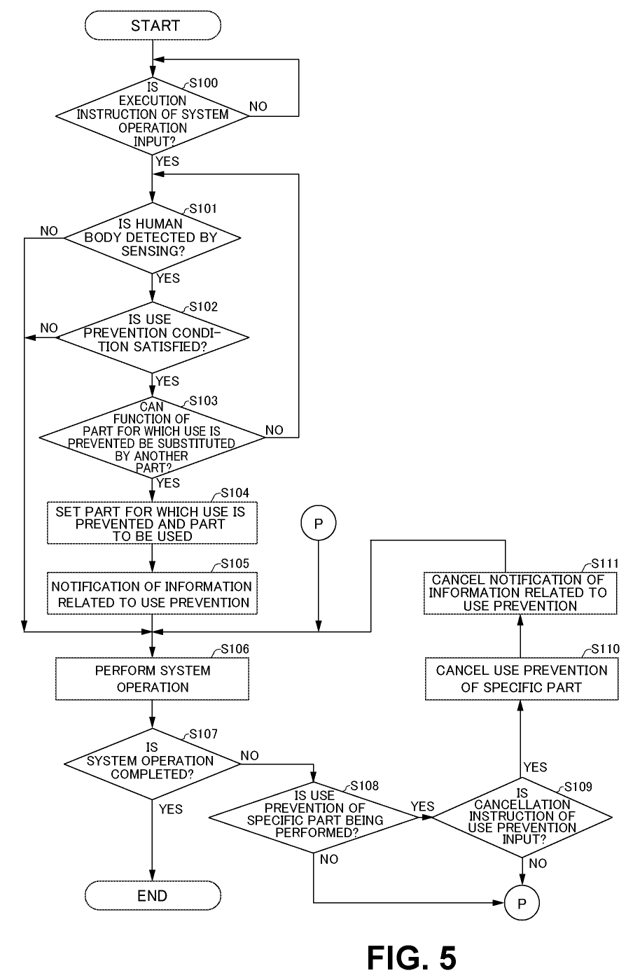

The detection performance and the detection accuracy of the human body by the detection unit 32 are affected by the overall configuration of the image forming system 10 and the environment in which the image forming system 10 is installed. With respect to the detection of the human body by the detection unit 32, it is desirable to set predetermined settings in a recommended environment of a manufacturer providing the image forming system 10 and to adjust various conditions such as adoption of a device layout of the image forming system 10, selection of installation positions of the wireless transmitter 30 and the wireless receiver 31, and setting of radio wave intensity and detection sensitivity in the detection unit 32 based on the predetermined settings. Such a step of adjusting various conditions related to the human body detection is performed as a preparation stage before processing (image forming processing) when the image forming system 10 is actually used, and the processing will be described later with reference to the flowchart of FIG. 5.

In addition, the detection performance and the detection accuracy of the human body by the detection unit 32 are affected by electromagnetic waves emitted from other electronic devices installed around the image forming system 10. Therefore, for the detection of the human body by the detection unit 32, at a place where the image forming system 10 is installed, when the image forming system 10 is in a standby state in which the image forming processing is not executed, it is desirable to cause the detection unit 32 to acquire data by measuring a change in the electromagnetic waves that change depending on an operating status of the peripheral electronic device and to perform detection in consideration of the influence of the surrounding electromagnetic waves. In other words, it is desirable that the detection unit 32 has a function (noise canceling function) of performing detection while removing an influence of radio waves other than the radio wave transmitted from the wireless transmitter 30 based on information related to the surrounding electromagnetic waves that is acquired in advance. Thereby, the accuracy of the human body detection by the detection unit 32 can be improved.

In normal use of the image forming system 10, examples of work that is assumed to be performed on the image forming system 10 at a relatively high frequency by the operator Q who is a user include replenishment of paper to the first paper feeding unit 13 and the second paper feeding unit 14 and transport of paper from the first paper discharge unit 15 and the second paper discharge unit 16. When the operator Q is performing these operations, it is desirable to stop the paper feeding operation and the paper discharge operation by the medium transport mechanism in the corresponding part. The control unit 20 determines (estimates) the work content performed by the operator Q in each of the plurality of control target parts included in the image forming system 10 based on the human body information (information of the human body and the posture of the human body) of the operator Q that is detected by using the wireless LAN sensing, and performs use prevention processing of preventing the use of the control target part that is used for the work by the operator Q without deteriorating the productivity of the image forming system 10 as much as possible.

FIG. 5 is a flowchart illustrating a flow of control related to the use prevention processing in the image forming system 10. The determination step in this flowchart is executed by the control unit 20.

In step S100, it is determined whether or not an instruction to execute a system operation of the image forming system 10 is input to the control unit 20. Specifically, the system operation is an operation including a series of image forming processing including feeding of paper from the first paper feeding unit 13 or the second paper feeding unit 14 to the image forming unit 11, image formation on paper using the image forming module 12 of the image forming unit 11, and discharge of paper from the image forming unit 11 to the first paper discharge unit 15 or the second paper discharge unit 16. That is, in step S100, it is checked whether or not an execution instruction of the image forming processing is input to the control unit 20.

In a case where an execution instruction of the system operation (image forming processing) is not input (NO in step S100), the operation itself to be prevented from being executed is not performed, and thus, it is not necessary to perform use prevention according to the position and the posture of the operator Q. Therefore, the loop is performed in a state where the determination in step S100 is NO until an execution instruction of the system operation is input (until the determination in step S100 is YES).

When an execution instruction of the system operation is input, the process proceeds to step S101. In step S101, the determination unit 23 of the control unit 20 determines whether or not an operator Q (human body) is detected based on the detection result of the wireless LAN sensing in the detection unit 32. In other words, it is determined whether or not an operator Q stays in the vicinity of the image forming system 10. In a case where an operator Q (human body) is detected, the determination in step S101 is YES, and the process proceeds to step S102. In a case where an operator Q (human body) is not detected, the determination in step S101 is NO, and the process proceeds to step S106.

In step S102, the determination unit 23 of the control unit 20 determines whether or not the human body information of the operator Q (human body) detected by the detection unit 32 satisfies a use prevention condition.

The use prevention condition means a situation where the operator Q is performing a specific work on any one of the plurality of control target parts (the image forming unit 11, the paper feeding units 13 and 14, and the paper discharge units 15 and 16) of the image forming system 10 and it is estimated that it is desirable not to operate the control target part being worked.

The presence of the operator Q (human body) at any one of the plurality of operation positions E1 to E5 in the vicinity of the plurality of control target parts in the image forming system 10 is a precondition that the use prevention condition is satisfied.

As an additional condition of the use prevention condition, the determination unit 23 of the control unit 20 detects a posture and a detailed position of the body of the operator Q (human body) staying at any one of the operation positions E1 to E5, and estimates the work content that the operator Q intends to perform.

For example, in a case where the hand of the operator Q staying at the second operation position E2 or the third operation position E3 is in the vicinity of the paper feeding tray 13a of the first paper feeding unit 13 or in the vicinity of the paper feeding tray 14a of the second paper feeding unit 14, the determination unit 23 of the control unit 20 estimates that the operator Q is performing an operation of replenishing paper to the paper feeding tray 13a or the paper feeding tray 14a. Even in a case where the position of the hand of the operator Q is not directly detected, it is possible to estimate that the paper replenishing operation is being performed based on the overall posture of the body of the operator Q.

In a case where the hand of the operator Q staying at the fourth operation position E4 or the fifth operation position E5 is in the vicinity of the paper discharge tray 15a of the first paper discharge unit 15 or in the vicinity of the paper discharge tray 16a of the second paper discharge unit 16, the determination unit 23 of the control unit 20 estimates that the operator Q is performing an operation of discharging the paper loaded on the paper discharge tray 15a or the paper discharge tray 16a. Even in a case where the position of the hand of the operator Q is not directly detected, it is possible to estimate that paper discharge work is being performed based on the overall posture of the body of the operator Q.

In a case where the operator Q staying at the first operation position E1 takes a predetermined posture (a posture in which the operator Q is assumed to access the image forming module 12 or the paper transport path in the image forming unit 11), the determination unit 23 of the control unit 20 estimates that the operator Q is performing maintenance work related to the image forming unit 11.

In a case where these estimations are established, the operator Q would be performing predetermined work on the control target part (any one of the image forming unit 11, the paper feeding units 13 and 14, and the paper discharge units 15 and 16) in the vicinity of the operation position (any one of E1 to E5) at which the operator Q is staying, and thus, it is determined that the use prevention condition is satisfied. Thereby, the determination in step S102 is YES, and the process proceeds to step S103. In a case of a condition in which these estimations are not established, the determination in step S102 is NO, and the process proceeds to step S106.

Note that, in a situation where the operator Q stays at the first operation position E1, in a state where the operator Q is not accessing the inside of the image forming unit 11 but is not performing any work or is only looking at the operation unit 17, it is not necessary to prevent the use of the image forming unit 11. In such a case, the determination unit 23 of the control unit 20 determines that the use prevention condition is not satisfied in consideration of information such as the posture of the operator Q and the operation content of the operator Q that is input to the operation unit 17. That is, the determination in step S102 is NO.

In addition, in a situation where the operator Q stays at any one of the second operation position E2, the third operation position E3, the fourth operation position E4, and the fifth operation position E5, in a state where no work is performed on each of the paper feeding units 13 and 14 and each of the paper discharge units 15 and 16 (a state where the operator does not access each of the paper feeding trays 13a and 14a and each of the paper discharge trays 15a and 16a), there is no need to prevent the use of each of the paper feeding units 13 and 14 and each of the paper discharge units 15 and 16. In such a case, the determination unit 23 of the control unit 20 determines that the use prevention condition is not satisfied. That is, the determination in step S102 is NO.

In this way, by using the human body information detected using the detection unit 32, it is possible to determine whether or not the use prevention condition is satisfied with high accuracy in consideration of the information related to the posture of the operator Q and the detailed position of each part of the body of the operator Q, in addition to the position information of the region where the operator Q stays. Thereby, it is possible to reliably select the control target part that requires use prevention as the use prevention target, and it is possible not to perform unnecessary use prevention for the control target part that does not require use prevention. Thus, it is possible to reduce a downtime of the image forming system 10.

In step S103, it is determined whether or not the function of the control target part that satisfies the use prevention condition (it is estimated that the operator Q is performing a specific work) can be substituted by another control target part.

For example, both the first paper feeding unit 13 and the second paper feeding unit 14 function as a medium feeding unit. Therefore, in a case where a type and a size of the paper fed by the first paper feeding unit 13 and a type and a size of the paper fed by the second paper feeding unit 14 match with each other or are similar to each other, the first paper feeding unit 13 and the second paper feeding unit 14 have functions that can be substituted for each other. Thereby, in a case where the operator Q staying at the second operation position E2 is performing work such as paper replenishment to the first paper feeding unit 13, the function of feeding paper to the image forming unit 11 can be performed by the second paper feeding unit 14 instead of the first paper feeding unit 13. Conversely, in a case where the operator Q staying at the third operation position E3 is performing work such as paper replenishment to the second paper feeding unit 14, the function of feeding paper to the image forming unit 11 can be performed by the first paper feeding unit 13 instead of the second paper feeding unit 14.

Further, both the first paper discharge unit 15 and the second paper discharge unit 16 function as a medium discharge unit. Therefore, in a case where a type and a size of paper that can be received by the first paper discharge unit 15 and a type and a size of paper that can be received by the second paper discharge unit 16 match with each other or are similar to each other, the first paper discharge unit 15 and the second paper discharge unit 16 have functions that can be substituted for each other. Thereby, in a case where the operator Q staying at the fourth operation position E4 is performing work such as discharging paper to the first paper discharge unit 15, the paper discharge destination from the image forming unit 11 can be set to the second paper discharge unit 16 instead of the first paper discharge unit 15. Conversely, in a case where the operator Q staying at the fifth operation position E5 is performing work such as discharging paper to the second paper discharge unit 16, the paper discharge destination from the image forming unit 11 can be set to the first paper discharge unit 15 instead of the second paper discharge unit 16.

As described above, in a case where the first paper feeding unit 13 and the second paper feeding unit 14 have functions that can be substituted for each other, the first paper discharge unit 15 and the second paper discharge unit 16 have functions that can be substituted for each other, and any one of the paper feeding units 13 and 14 and the paper discharge units 15 and 16 is a control target part that satisfies the use prevention condition, the determination in step S103 is YES. In a case where the determination in step S103 is YES, the process proceeds to step S104.

Since the image forming system 10 includes only one image forming unit 11, in a case where the operator Q staying at the first operation position E1 accesses the image forming module 12 or the transport path in the image forming unit 11 to perform work, there is no alternative part for performing image formation, and as a result, the image forming system 10 cannot proceed with the image forming processing. That is, in a case where the image forming unit 11 is the control target part that satisfies the use prevention condition, the determination in step S103 is NO. In a case where the determination in step S103 is NO, the process returns to step S101. While the detection unit 32 detects that the operator Q accesses the inside of the image forming unit 11 and continues the work, the process from step S101 to step S103 is looped. Thereby, it is possible to prevent the image forming system 10 from being wastefully operated under a situation where image formation cannot be executed in the image forming unit 11.

Note that, unlike the image forming system 10 according to the present embodiment, in an image forming system having a configuration including a plurality of image forming blocks (image forming units), in a case where it is determined in step S102 that a specific image forming block satisfies the use prevention condition, it is determined in step S103 that the function can be substituted by another image forming block. In this case, the process can proceed to step S104.

In step S104, the control unit 20 sets the use prevention so as not to operate the control target part determined to satisfy the use prevention condition in step S102, and then selects (changes) a use part so as to use another control target part that can substitute the function of the control target part.

For example, in a case where the operator Q is performing work such as paper replenishment to the first paper feeding unit 13, the control unit 20 performs setting so as to prevent the operation of using the first paper feeding unit 13 and cause the second paper feeding unit 14 to feed paper to the image forming unit 11. In a case where the operator Q is performing work such as paper replenishment to the second paper feeding unit 14, the control unit 20 performs setting so as to prevent the operation of using the second paper feeding unit 14 and cause the first paper feeding unit 13 to feed paper to the image forming unit 11.

In a case where the operator Q is performing work such as paper transport in the first paper discharge unit 15, the control unit 20 performs setting so as to prevent the operation of using the first paper discharge unit 15 and cause the second paper discharge unit 16 to discharge paper. In a case where the operator Q is performing work such as paper transport in the second paper discharge unit 16, the control unit 20 performs setting so as to prevent the operation of using the second paper discharge unit 16 and cause the first paper discharge unit 15 to discharge paper.

When the setting of the control target part to be prevented from being used and the control target part to be used is completed in step S104, the process proceeds to step S105. In step S105, notification of information related to the use prevention that is set in step S104 is performed. For example, the control unit 20 transmits a display control signal to the operation unit 17 to display a use prevention notification 40 as illustrated in FIG. 4. In the display example of the use prevention notification 40 of FIG. 4, a fact that the operator Q staying in the vicinity of the first paper feeding unit 13 (the second operation position E2) is detected and a fact that the use of the first paper feeding unit 13, which is the control target part corresponding to the stay position, is being prevented are displayed on the operation unit 17 in a form of text display information.

Note that the information notification of the use prevention in step S105 may be performed not only by the display of the use prevention notification 40 on the operation unit 17 that also serves as the input device but also by a method such as display on a display unit provided in the image forming system 10 separately from the operation unit 17 or sound production by voice from a speaker. Alternatively, the information notification of the use prevention may be remotely performed using a display unit, a speaker, or the like included in the remote control unit 18.

As illustrated in FIG. 4, the information notification performed by the control unit 20 in step S105 further includes a use prevention selection menu 41 for inputting selection as to whether or not to cancel the use prevention that is set in step S104. The use prevention selection menu 41 is displayed on the operation unit 17, and includes a first selection unit 41a for selecting cancellation of the use prevention and a second selection unit 41b for selecting continuation of the use prevention.

The process proceeds to step S106 subsequent to step S105. In a case where the determination in step S101 is NO and in a case where the determination in step S102 is NO, the process directly proceeds to step S106 without performing the processing in step S104 or step S105.

In step S106, the control unit 20 performs image forming processing by controlling each control target part of the image forming system 10, the image forming processing including feeding of paper to the image forming unit 11, image formation on the paper by using the image forming module 12, and discharge of the paper from the image forming unit 11.

In the series of image forming processing in step S106, the control unit 20 performs control so as not to operate the control target part for which the use prevention is set in step S104. Specifically, in a case where any one of the first paper feeding unit 13 and the second paper feeding unit 14 is set as the target part of the use prevention, the control unit 20 performs control so as not to operate the paper feeding unit which is a target of the use prevention, that is, so as not to operate rollers for the paper feeding operation, a mechanism for adjusting heights of the paper feeding trays 13a and 14a, and the like. In a case where any one of the first paper discharge unit 15 and the second paper discharge unit 16 is set as the use prevention target part, the control unit 20 performs control so as not to operate the paper discharge unit which is a target of the use prevention, that is, so as not to operate rollers for the paper discharge operation, a mechanism for adjusting heights of the paper discharge trays 15a and 16a, and fences for aligning sheets of paper to be discharged to the paper discharge trays 15a and 16a.

Thereby, it is possible to stop the control target part for which the use prevention is set and to cause the operator Q to safely and reliably perform the work such as replenishment of paper and transport of paper while causing the other control target part for which the use prevention is not set to operate and to execute the image forming processing.

In a case where the determination in step S101 is NO and the process proceeds to step S106 and in a case where the determination in step S102 is NO and the process proceeds to step S106, the control unit 20 executes a series of image forming processing (system operation) without setting the use prevention for a specific control target part.

The process performed by the control unit 20 proceeds to step S107 while the system operation in step S106 is being executed. In a state where the system operation is executed, the determination in step S107 is NO, and the process proceeds to step S108. In step S108, the control unit 20 determines whether or not the use prevention which is set in step S104 is performed. In a case where the use prevention for the specific control target part determined to satisfy the use prevention condition in step S102 is performed, the determination in step S108 is YES, and the process proceeds to step S109. In a case where the use prevention is not performed, the determination in step S108 is NO, and the process proceeds to step S106 and step S107 and the processing of the flowchart of FIG. 5 is continued until the system operation is completed.

In step S109, it is determined whether an operation of cancelling the use prevention by the operator Q or an operation of continuing the use prevention by the operator Q is received. While the use prevention is performed in the specific control target part, information notification related to the use prevention in step S105 described above is continuously performed. The operator Q obtains information of the control target part for which the use prevention is set by viewing the use prevention notification 40 (FIG. 4) displayed on the operation unit 17, and can instruct cancellation or continuation of the use prevention based on the information.

For example, in a case where the work such as replenishment of paper to each of the paper feeding units 13 and 14 and discharge of paper in each of the paper discharge units 15 and 16 is completed, and the operator Q determines that it is not necessary to further continue the use prevention for the part where the work has been performed, a cancellation instruction of the use prevention can be issued. The cancellation instruction of the use prevention is performed by an operation in which the operator Q touches the first selection unit 41a of the use prevention selection menu 41 displayed on the operation unit 17.

When the cancellation instruction of the use prevention is input to the control unit 20, the determination in step S109 is YES, and the process proceeds to step S110. In step S110, the control unit 20 cancels the setting of the use prevention that is set in step S104 described above. For example, in a case where the use prevention is set for either the first paper feeding unit 13 or the second paper feeding unit 14, the control unit 20 cancels the use prevention, and resets the setting such that paper feeding is permitted from both the first paper feeding unit 13 and the second paper feeding unit 14. In a case where the use prevention is set for either the first paper discharge unit 15 or the second paper discharge unit 16, the control unit 20 cancels the use prevention, and resets the setting such that paper discharge to both the first paper discharge unit 15 and the second paper discharge unit 16 is permitted.

When cancelling the use prevention in step S110, the control unit 20 may change the priority order of the operation so as to preferentially use the control target part for which the use prevention is cancelled. For example, in a case where the use prevention for the first paper feeding unit 13 is cancelled, the control unit 20 performs control such that the paper feeding operation being performed in the second paper feeding unit 14 is switched to a paper feeding operation in the first paper feeding unit 13. In addition, in a case where the use prevention for the first paper discharge unit 15 is cancelled, the control unit 20 performs control such that the paper discharge operation being performed in the second paper discharge unit 16 so far is switched to a paper discharge operation in the first paper discharge unit 15. With such control, the first paper feeding unit 13 and the second paper feeding unit 14 can be efficiently used, and the first paper discharge unit 15 and the second paper discharge unit 16 can be efficiently used.

Here, resetting of use permission due to the cancellation of the use prevention in step S110 does not mean that the control target part for which the use prevention is cancelled is necessarily used. For example, in a case where a type and a size of the paper loaded on the paper feeding unit for which the use prevention is cancelled or a type and a size of the paper that can be discharged to the paper discharge unit for which the use prevention is cancelled do not match a type and a size of the paper that is set in the image formation job currently in progress, it is not appropriate to select the paper feeding unit or the paper discharge unit as a target for paper feeding or paper discharge. In addition, in a case where a plurality of sheets of paper are continuously discharged, there are restrictions such as the arrangement order of the sheets of paper on which an image is formed, and it may not be appropriate to randomly distribute the discharge destinations to a plurality of paper discharge units. Therefore, it is preferable to include processing in which the control unit 20 determines whether or not the control target part for which the use prevention is cancelled in step S110 can be used based on the content of the image formation job and the like, and the control unit 20 actually uses the control target part in a case where it is determined that the use of the control target part is appropriate.

In step S111 subsequent to step S110, the control unit 20 cancels the information notification related to the use prevention that is performed in step S105. For example, the control unit 20 transmits a display control signal to the operation unit 17 to end the display of the use prevention notification 40 and the use prevention selection menu 41 as illustrated in FIG. 4. When step S111 is completed, the process returns to step S106.

The operator Q can instruct continuation of the use prevention in a state where the use prevention notification 40 and the use prevention selection menu 41 are displayed on the operation unit 17 (that is, a state where the use prevention is performed in the specific control target part). The continuation instruction of the use prevention is performed by an operation of touching a second selection unit 41b of the use prevention selection menu 41 displayed on operation unit 17. In this case, the determination in step S109 is NO, and the process directly returns to step S106 without passing through step S110 and step S111.

In a case where a selection operation on the use prevention selection menu 41 by the operator Q is not performed for a predetermined time or longer in step S109, the determination in step S109 may be automatically set to NO, and the process may return to step S106.

From the above, in a case of returning from step S109 to step S106, there are patterns including a pattern in which the use prevention of the specific control target part is cancelled in step S110 and a pattern in which the use prevention continues without being cancelled.

In the former pattern, the determination in the next step S108 is NO, and the process proceeds to step S106 and step S107. In the latter pattern, the determination in step S108 is YES, and the process proceeds to step S109. That is, during the system operation involving the use prevention of the specific control target part (during the image forming processing), the control unit 20 continuously checks whether or not the operator Q performs the operation of cancelling the use prevention, and in a case where the operator Q actively performs the operation of cancelling the use prevention, the use prevention is cancelled.

In step S107, the control unit 20 determines whether or not a series of image forming processing (system operation) based on the image formation job is completed. In a case where the image forming processing is completed, the determination in step S107 is YES, and the processing of the flowchart of FIG. 5 is terminated. Until the image forming processing is completed, the determination in step S107 is NO, and the processing returns to step S108.

During the system operation, the operator Q may complete a series of image forming processes based on the image formation job without performing an operation of cancelling the use prevention (an operation of the first selection unit 41a of the use prevention selection menu 41). In this case, the system operation is completed while continuing the use prevention of the control target part that is set in step S104. Then, after the system operation is completed, the control unit 20 performs processing of cancelling the use prevention.

In the above description of the flowchart, the use prevention of the control target part that is set in step S104 is canceled by the active cancel operation of the operator Q. With such control, it is possible to prevent the use prevention from being canceled against the intention of the operator Q while the operator Q is performing work on the control target part.

Note that, after the start of the system operation in step S106, detection of the human body and the posture of the human body is continuously performed using the detection unit 32, and in a case where it is estimated that the use prevention may be cancelled, the control unit 20 may perform notification for recommending cancellation of the use prevention via the operation unit 17 or the like. When the operator Q receives the notification, the operator Q performs an operation of cancelling the use prevention (an operation of the first selection unit 41a of the use prevention selection menu 41), and thus, unnecessary continuation of the use prevention can be avoided.

In the above-described processing described with reference to the flowchart of FIG. 5, when the human body and the posture of the human body are detected using the detection unit 32, the control target part for which the operator Q is estimated to be performing work is set as the use prevention target. As described above, in the normal use of the image forming system 10, it is often desirable not to operate the control target part that is performing work when the work is assumed to be performed by the operator Q who is the user. Therefore, the control content that mainly focuses on the use prevention is selected.

On the other hand, in a case where an administrator who performs maintenance of the image forming system 10 or a person in charge of repair of a manufacturer is the operator Q, it is assumed that the operator Q operates a specific control target part while accessing the control target part to check a situation and an error. In this case, it is desirable to perform control to preferentially use (operate) the specific control target part that the operator Q is accessing, instead of the use prevention. Therefore, in the control of the image forming system 10, a step of selecting whether the control target part for which the operator Q (human body) is determined to be nearby by the human body detection by the detection unit 32 is set as the use prevention target or the priority use target may be included.

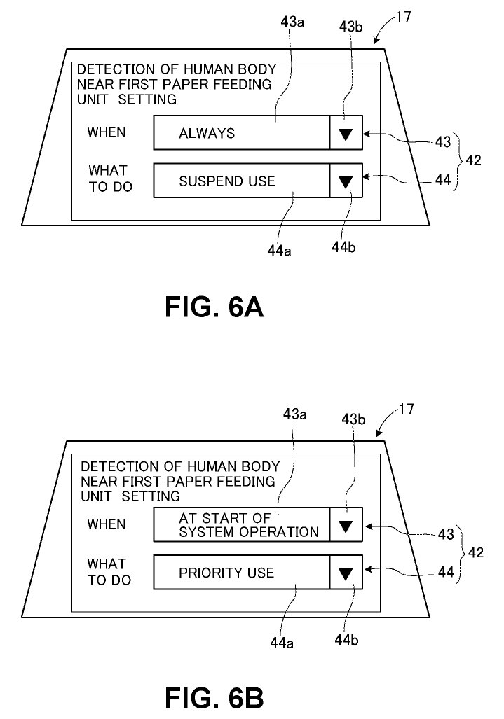

FIGS. 6A and 6B illustrate an example of operation modes in which the first control mode in which the control target part determined to be near the operator Q is set as the use prevention target and the second control mode in which the control target part is set as the priority use target can be selected. The display examples of FIGS. 6A and 6B are applied to a case where the control target part near the operator Q is the first paper feeding unit 13.

An operation mode setting menu 42 illustrated in FIGS. 6A and 6B is displayed on the operation unit 17. The operation mode setting menu 42 includes a first setting unit 43 and a second setting unit 44. The setting units 43 and 44 respectively include information display units 43a and 44a for displaying the selected content, and pull-down buttons 43b and 44b for switching the content to be displayed on the information display units 43a and 44a. When the operator Q touches the pull-down buttons 43b and 44b, a list of selectable content is displayed by expanding the display ranges of the information display sections 43a and 44a. When the operator Q touches a desired content from the list, the content is selected, and only the selected content is displayed on the information display sections 43a and 44a.

The first setting unit 43 sets a temporal condition for enabling the content that is set in the operation mode setting menu 42. The second setting unit 44 sets an operation mode. Specifically, “suspend use” meaning the use prevention in the first control mode and “preferentially use” meaning preferential use in the second control mode are prepared as content that can be set by the second setting unit 44.

FIG. 6A is a display example of the operation mode setting menu 42 in the first control mode in which, in a case where it is determined that the control target part (first paper feeding unit 13) is near the operator Q (human body), the control target part is set as a use prevention target. In the second setting unit 44, the control content of the use prevention is selected. In the first setting unit 43, it is selected to always apply the use prevention during the operation of the image forming system 10.

FIG. 6B is a display example of the operation mode setting menu 42 in the second control mode in which, in a case where it is determined that the control target part (first paper feeding unit 13) is near the operator Q (human body), the control target part is set as a priority use target. In the second setting unit 44, the control content for priority use is selected. In the first setting unit 43, it is selected to apply the priority use at the start of the system operation of the image forming system 10.

A flow of processing including selection of the control mode as illustrated in FIGS. 6A and 6B will be briefly described. First, processing similar to the processing in step S100 and step S101 illustrated in FIG. 5 is performed. That is, by the wireless LAN sensing performed via the detection unit 32, it is detected that the control target part is near the operator Q (human body) and the operator Q is in a situation of performing a specific work on the control target part.

Subsequently, the control unit 20 checks the content that is set in the operation mode setting menu 42. In a case where the setting of the operation mode setting menu 42 is the content of the first control mode as illustrated in FIG. 6A, the control unit 20 performs processing that mainly focuses on the use prevention. The processing content in this case is similar to the processing content after step S102 of the flowchart described above with reference to FIG. 5, and thus description thereof is omitted here.

In a case where the setting of the operation mode setting menu 42 is the content of the second control mode as illustrated in FIG. 6B, the control unit 20 performs setting such that the control target part that is determined to be near the operator Q (human body) in step S101 is preferentially used. Then, the control unit 20 causes the image forming system 10 to perform a system operation (image forming processing). At this time, the control unit 20 performs control such that the control target part designated to be preferentially used is preferentially operated.

For example, in a case where one of the first paper feeding unit 13 and the second paper feeding unit 14 is a priority use target, the paper feeding operation from the paper feeding unit that is set as the priority use target is preferentially performed. In a case where either the first paper discharge unit 15 or the second paper discharge unit 16 is a priority use target, the paper discharge operation to the paper discharge unit that is set as the priority use target is preferentially performed. In a case where the image forming unit 11 is a priority use target, the image forming unit 11 is operated to execute image formation on paper by the image forming module 12.

By performing control in this manner, the control target part in a state where the operator Q stays nearby is operated without delay, and the operator Q can quickly and reliably confirm the operation status. Therefore, in a case where the operator Q performs maintenance of the image forming system 10, it is easy to recognize an occurrence state and a cause of an error, and it is possible to perform an efficient maintenance work according to the intention of the operator Q.

As described above, the image forming system 10 according to the present embodiment includes the wireless transmitter 30 and the wireless receiver 31 included in the detection unit 32, and the control unit 20 detects the human body and the posture of the human body from a reception signal obtained by receiving the radio wave transmitted from the wireless transmitter 30 by the wireless receiver 31, and determines the control target part near the human body. More specifically, the image forming system 10 applies a sensing (wireless LAN sensing) technique using a method of detecting a propagation state of a radio wave to be transmitted and received, transmits a radio wave from the wireless transmitter 30 such that the radio wave reaches a plurality of operation positions E1 to E5 corresponding to a plurality of control target parts, and receives the radio wave by the wireless receiver 31. Thereby, it is possible to detect approach of the human body to the image forming system 10 and to acquire information such as a detailed position and a posture of the human body. Thus, it is possible to specify the control target part near the human body.

In the sensing using such a method, it is possible to acquire a large amount of information of the human body in the vicinity of the image forming system 10 by using a small number of wireless transmitters 30 and wireless receivers 31. In addition, as compared with a method of calculating a standing position and a movement trajectory of the human body by arranging a large number of human sensing sensors, the configuration of the detection unit 32 can be simplified, and there are few restrictions on the arrangement of the detection unit 32. Further, the sensing by the detection unit 32 can improve accuracy by accumulating data and repeating machine learning. Therefore, the control unit 20 performs determination based on the detection by the detection unit 32, and thus, it is possible to determine the use condition of each part of the image forming system 10 by the operator Q with high accuracy with a simpler configuration than the detection using the existing human sensing sensors, and to realize operation control that is optimized according to the use condition and has high effectiveness.

Further, the information acquired by sensing using the detection unit 32 can be configured not to include personal information such as a face or confidential information on a document, unlike a captured image. Thereby, while improving convenience by controlling the operation of the image forming system 10 by using information of the position and the posture of the human body detected by sensing, it is possible to realize the operation of the image forming system 10 even in an environment where privacy protection and advanced security are required.

In addition, in the sensing by the detection unit 32, it is not necessary to provide a special instrument for identification on the human body to be detected, and the detection unit 32 can be configured as an independent detection system on the image forming system 10 side. Thus, labor for operation and management is reduced.

As one mode of the operation of the image forming system 10 according to the present embodiment, as described above with reference to the flowchart of FIG. 5, when receiving an execution instruction of the image forming processing of forming an image on paper, the control unit 20 performs control to prevent the use of the control target part determined to be near the human body. That is, the use prevention is performed by the control of the control unit 20 on the control target part for which the operator Q is presumed to be performing some work.

By such control including the use prevention, the work being performed by the operator Q on the control target part is not hindered by the operation of the control target part, and the work can be efficiently performed. In addition, when performing work, it is not necessary for the operator himself/herself to input a use prevention instruction of the control target part. The control unit 20 automatically determines the use prevention based on the human body information detected via the detection unit 32, and executes the use prevention. Thereby, it is possible to eliminate the need for the operator Q to perform any extra operations, and thus, work efficiency is excellent.

In a case where there are a plurality of control target parts that can function in place of each other, the control unit 20 performs control to select and use another control target part (a control target part for which the use prevention is not set) when preventing use of a specific control target part. Specifically, in the image forming system 10 according to the present embodiment, the first paper feeding unit 13 and the second paper feeding unit 14 are two control target parts that can function in place of each other, and the control unit 20 performs control to prevent the use of one of the first paper feeding unit 13 and the second paper feeding unit 14 that is determined to be near the human body and to use the other of the first paper feeding unit 13 and the second paper feeding unit 14. In addition, the first paper discharge unit 15 and the second paper discharge unit 16 are two control target parts that can function in place of each other, and the control unit 20 performs control to prevent the use of one of the first paper discharge unit 15 and the second paper discharge unit 16 that is determined to be near the human body and to use the other of the first paper discharge unit 15 and the second paper discharge unit 16.

As described above, in a case where the use prevention of the paper feeding unit or the paper discharge unit is set based on the position and the posture of the human body detected using the detection unit 32, the control unit 20 automatically selects and uses the other paper feeding unit and the other paper discharge unit for which the use prevention is not set. Thereby, the system operation (image forming processing) can be executed even while the operator Q is performing work such as replenishment of paper to the paper feeding unit and transport of paper from the paper discharge unit, and the productivity of the image forming system 10 can be improved as compared with a case where the system operation is stopped during the work.

The image forming system 10 according to the present embodiment includes the operation unit 17, and displays the use prevention notification 40 and the use prevention selection menu 41 on the operation unit 17 under the control of the control unit 20 in a state where the control unit 20 is performing control to prevent the use of the control target part (refer to FIG. 4). Then, when the operator Q inputs a cancellation instruction of the use prevention by operating the first selection unit 41a of the use prevention selection menu 41, the control unit 20 performs control to cancel the use prevention of the control target part.

As described above, the use prevention that is set for the control target part can be cancelled by the operation of the operator Q, and thus, it is possible to prevent the unnecessary continuation of the use prevention in the control target part for which the use prevention is unnecessary, and to realize the efficient operation of the image forming system 10.

As described above, the control unit 20 may perform control such that the control target part for which the use prevention is canceled by the operation of the operator Q is preferentially used. Alternatively, after the cancellation of the use prevention, the control unit 20 may perform control to select the control target part to be used again by determination.

As one mode of the operation of the image forming system 10 according to the present embodiment, as described above with reference to FIGS. 6A and 6B, the operation mode setting menu 42 is displayed on the operation unit 17, and the operator Q can select the first control mode for causing the control unit 20 to perform the control to prevent the use of the control target part that is determined to be near the human body and the second control mode for causing the control unit 20 to perform the control to preferentially use the control target part that is determined to be near the human body by the operation of the first setting unit 43 or the second setting unit 44 of the operation mode setting menu 42.

Since it is possible to select the first control mode and the second control mode in this manner, it is possible to cause the control unit 20 to perform control that is optimized for the work content performed by the operator Q on the control target part. For example, in a case where the operator Q is a user when the image forming system 10 is normally used and performs work that is often performed at the time of normal use of the apparatus, such as replenishment of paper to each of the paper feeding units 13 and 14, transport of paper from each of the paper discharge units 15 and 16, and removing jammed paper due to a transport failure, by selecting the first control mode, it is possible to prevent the use of the control target part by the operator Q during the work, and prevent an operation that hinders the work from being performed. In a case where the operator Q is an administrator or a person in charge of repair who performs maintenance or repair of the image forming system 10, by selecting the second control mode, it is possible to preferentially operate a control target part that is a work target of the operator Q and quickly and efficiently perform inspection or confirmation of a defect.

In a preparation stage of using the image forming system 10, data related to electromagnetic waves emitted from the peripheral electronic devices is acquired. When the human body and the posture of the human body of the operator Q are detected by performing sensing, the detection unit 32 has a function of removing an influence of surrounding radio waves other than the radio wave transmitted from the wireless transmitter 30 based on the surrounding electromagnetic wave data acquired in advance. Thereby, the detection accuracy of the information of the human body near the image forming system 10 can be improved.

The technique according to the present disclosure is highly useful in a large apparatus in which the paper feeding units 13 and 14 and the paper discharge units 15 and 16 are connected to the outside of the image forming unit 11 as in the illustrated image forming system 10. In such a large image forming system 10, since the standing position and the posture of the operator Q greatly change according to the type and the content of the work, the wireless LAN sensing that can detect the human body and the posture of the human body over a relatively wide range with a simple configuration is highly useful.

On the other hand, the technique according to the present disclosure can also be applied to an image forming apparatus having an integrated structure including the paper feeding units and the paper discharge units in one housing. Due to improvement of the detection accuracy by machine learning, the wireless LAN sensing can separately detect detailed human body information according to each work state even in a situation where the operator accesses different parts of one small housing.

Note that the illustrated image forming system 10 includes the two paper feeding units 13 and 14 and the two paper discharge units 15 and 16, but the number of medium feeding units (paper feeding units) and medium discharge units (paper discharge units) included in the image forming system according to the present disclosure is not limited thereto. For example, the number of feeding units that feed the medium and the number of discharge units that discharge the medium may be one or three or more. In a case where there is one feeding unit or one discharge unit, there is no other control target part that substitutes the same function. Therefore, in a case where the feeding unit or the discharge unit is selected as the use prevention target, the determination in step S103 of the flowchart of FIG. 5 is NO, and the medium feeding operation by the alternative feeding unit or the medium discharge operation to the alternative discharge unit is not executed.

Note that the present invention is not limited to the above-described embodiment as it is, and the components can be modified and embodied without departing from the gist of the present invention at an implementation stage. Furthermore, various inventions can be made by appropriately combining a plurality of components disclosed in the embodiment. For example, all the components described in the embodiment may be appropriately combined. It is a matter of course that various modifications and applications can be made without departing from the gist of the invention. Hereinafter, some inventions described in the specification of the present application will be additionally described.

According to an aspect, an image forming system includes:

an image forming unit that forms an image on a medium;

at least one feeding unit that feeds the medium to the image forming unit;

at least one discharge unit that discharges the medium on which an image is formed by the image forming unit; and

a control unit that controls an operation of each of a plurality of control target parts including at least the image forming unit, the feeding unit, and the discharge unit, in which

a wireless transmitter and a wireless receiver are provided, and

the control unit detects a human body and a posture from a reception signal obtained by receiving a radio wave transmitted from the wireless transmitter by the wireless receiver, and determines the control target part near the human body.

According to another aspect, when receiving an execution instruction of image forming processing of forming an image on the medium, the control unit performs control to prevent use of the control target part that is determined to be near the human body.

According to another aspect, the image forming system further includes:

a plurality of the feeding units or a plurality of the discharge units, in which

the control unit performs control to prevent use of the feeding unit or the discharge unit that is determined to be near the human body, and performs control to use the other feeding units or the other discharge units.

According to another aspect, the image forming system further includes:

an operation unit, in which,

in a state where the control unit is performing control to prevent use of the control target part, when an operator inputs a cancellation instruction of the prevention to the operation unit, the control unit performs control to cancel the prevention.

According to another aspect, the image forming system further includes:

an operation unit, in which

an operator who operates the operation unit is allowed to select:

a first control mode in which the control unit performs control to prevent use of the control target part that is determined to be near the human body; and

a second control mode in which the control unit performs control to preferentially use the control target part that is determined to be near the human body.

According to another aspect, the control unit has a function of removing an influence of surrounding radio waves other than the radio wave transmitted from the wireless transmitter when detecting a human body and a posture from a reception signal obtained by receiving the radio wave transmitted from the wireless transmitter by the wireless receiver.

What is claimed is:

1. An image forming system comprising:
an image forming unit that forms an image on a medium;
at least one feeding unit that feeds the medium to the image forming unit;
at least one discharge unit that discharges the medium on which an image is formed by the image forming unit; and
a control unit that controls an operation of each of a plurality of control target parts including at least the image forming unit, the feeding unit, and the discharge unit, wherein
a wireless transmitter and a wireless receiver are provided, and
the control unit detects a human body and a posture from a reception signal obtained by receiving a radio wave transmitted from the wireless transmitter by the wireless receiver, and determines the control target part near the human body.

2. The image forming system according to claim 1, wherein, when receiving an execution instruction of image forming processing of forming an image on the medium, the control unit performs control to prevent use of the control target part that is determined to be near the human body.

3. The image forming system according to claim 2, further comprising:
a plurality of the feeding units or a plurality of the discharge units, wherein
the control unit performs control to prevent use of the feeding unit or the discharge unit that is determined to be near the human body, and performs control to use the other feeding units or the other discharge units.

4. The image forming system according to claim 2, further comprising:
an operation unit, wherein,
in a state where the control unit is performing control to prevent use of the control target part, when an operator inputs a cancellation instruction of the prevention to the operation unit, the control unit performs control to cancel the prevention.

5. The image forming system according to claim 1, further comprising:
an operation unit, wherein
an operator who operates the operation unit is allowed to select:
a first control mode in which the control unit performs control to prevent use of the control target part that is determined to be near the human body; and
a second control mode in which the control unit performs control to preferentially use the control target part that is determined to be near the human body.

6. The image forming system according to claim 1, wherein the control unit has a function of removing an influence of surrounding radio waves other than the radio wave transmitted from the wireless transmitter when detecting a human body and a posture from a reception signal obtained by receiving the radio wave transmitted from the wireless transmitter by the wireless receiver.
